(19) United States
(12) Patent Application Publication
(10) Pub. No.: US 2009/0165406 A1
(43) Pub. Date: Jul. 2, 2009

(54) INTEGRAL SILL CORNER WITH UPSTAND

(75) Inventors: Kevin A. Campbell, Klamath Falls, OR (US); John D. Stackpole, Klamath Falls, OR (US); Kenneth M. Hart, Klamath Falls, OR (US); Kenneth J. Christensen, Klamath Falls, OR (US)

Correspondence Address: NELSON MULLINS RILEY & SCARBOROUGH, LLP, 1320 MAIN STREET, 17TH FLOOR, COLUMBIA, SC, 29201, US

(73) Assignee: JELD-WEN, INC., Klamath Falls, OR (US)

(21) Appl. No.: 12/344,936

(22) Filed: Dec. 29, 2008

Related U.S. Application Data
(60) Provisional application No. 61/017,429, filed on Dec. 28, 2007.

(51) Int. Cl. E06B 1/70

(52) U.S. Cl. 52/211; 52/745.15

(57) ABSTRACT

A sill corner for use in a sill assembly supported on a base surface, the sill assembly comprising a vertical jamb and a lineal base member. The sill corner comprises a vertical component with a top surface adapted to receive the vertical jamb and a bottom surface adapted to abut the base surface. A horizontal component extends transversely from the vertical component and the horizontal and the vertical components are a unitary element. The top and bottom surfaces of the vertical component are separated by a height, the height being between about 1.00 and about 3.00 inches.

### CLAIM OF PRIORITY

The present application claims priority to U.S. Provisional Application No. 61/017,429, entitled “Integral Sill Corner with Upstand” and filed Dec. 28, 2007, the entire disclosure of which is incorporated by reference herein.

### FIELD OF THE INVENTION

The present invention relates generally to sills for windows and doors. More particularly, the present invention relates to a sill including an integrally formed sill corner with an upstand portion for forming a joint with a side jamb.

### BACKGROUND

It is not uncommon for typical window and door sill assemblies to suffer from air and water leakage intrusion due, in part, to their construction. A typical sill assembly will include a horizontal sill member and a pair of vertical members, or jambs, at each end of the horizontal sill member. A joint between the horizontal sill member and a corresponding vertical jamb is formed by abutting the ends of the two members at a corner. The vertical jamb can abut the top surface of the horizontal sill member, the horizontal sill member can abut a side surface of the vertical jamb, or the horizontal and vertical members can be joined at a mitered corner. For each of the noted methods, a joint exists between the two members at a corner that is low on the sill assembly and therefore susceptible to being exposed to the elements, such as water. Gaskets and wet sealants are frequently used to seal these joints. However, age, exposure to elements, thermal expansion and contraction, etc., lead to the degradation of these components, and therefore increase the potential for leakage of water through the joint and into the building structure.

As such, it would be advantageous to have a sill assembly in which joints in the lower-most corners of the sill assembly are eliminated. As well, it would be desirable for a sill assembly to be constructed so that any joints in the vicinity of the lower-most corners are raised a sufficient distance up along the vertical jamb components such that water intrusion due to differential pressures developed across the joints is lessened. As well, it would be desirable to positively join various components of the sill assembly rather than merely applying wet sealants, gaskets, etc., to these joints.

### SUMMARY OF THE INVENTION

One embodiment of the present invention provides a sill corner for use in a sill assembly supported on a base surface, the sill assembly also comprising a vertical jamb and a lineal base member. The sill corner comprises a vertical component with a top surface adapted to receive the vertical jamb and a bottom surface adapted to abut the base surface. A horizontal component extends transversely from the vertical component and the horizontal and the vertical components are integrally formed. The top and bottom surfaces of the vertical component are separated by a height, the height being between about 1.00 and about 3.00 inches.

Another embodiment of the present invention provides a sill assembly supported on a base surface, the sill assembly comprising a sill corner with a vertical component with a planar top surface and a horizontal component, the vertical and horizontal components being integrally formed. A vertical jamb comprises a planar bottom surface adapted to abut the planar top surface such that a joint is formed. The joint is disposed at a height above the base surface, the height being between about 1.00 and about 3.00 inches.

Another embodiment of the present invention provides a method of making a sill corner for use in a sill assembly supported on a base surface, the sill assembly comprising a vertical jamb and a lineal base member. The method comprises providing a vertical component with a substantially planar top surface adapted to receive the vertical jamb and a bottom surface adapted to abut the base surface and providing a horizontal component extending transversely from the vertical component. The horizontal and the vertical components are integrally formed, wherein the top surface of the vertical component is substantially parallel to the bottom surface of the vertical component and the top surface and the bottom surfaces are separated by a height, the height being between about 1.00 and about 3.00 inches.

Another embodiment of the present invention provides a sill assembly configured to be supported on a base surface, the sill assembly comprising a sill corner with a vertical component and a horizontal component, the vertical and horizontal components being integrally formed, the vertical component comprising a sealant pathway formed therein, and a sill cap with a first edge. The sill cap is configured to be slidably received by the horizontal component of the sill corner, and the sealant pathway is configured to both slidably receive the first edge of the sill cap and allow a fluid sealant to flow along the first edge within the sealant pathway.

Further details on each of these aspects of the present invention are set forth in the following description, figures and claims. It is to be understood that the invention is not limited in its application to the details set forth in the following description, figures and claims, but is capable of other embodiments and of being practiced or carried out in various ways.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of an embodiment of a sill corner assembly in accordance with the present invention;

FIG. 2A is a top view of the embodiment of an integral sill corner, as shown in FIG. 1, in accordance with the present invention;

FIG. 2B is a bottom view of the sill corner as shown in FIG. 2A;

FIG. 2C is a left-side view of the sill corner as shown in FIG. 2A;

FIG. 2D is a right-side view of the sill corner as shown in FIG. 2A;

FIG. 2E is a front view of the sill corner as shown in FIG. 2A;

FIG. 2F is a rear view of the sill corner as shown in FIG. 2A;

FIG. 3A is a top view of the embodiment of a lineal base member, as shown in FIG. 1, in accordance with the present invention;

FIG. 3B is a bottom view of the lineal base member as shown in FIG. 3A;

FIG. 3C is a right-side view of the lineal base member as shown in FIG. 3A;

FIGS. 4A and 4B are top and left-side views, respectively, of the embodiment of a sill cap, as shown in FIG. 1, in accordance with the present invention;

FIG. 5A is a top view of the embodiment of a sill strip, as shown in FIG. 1, in accordance with the present invention;

FIG. 5B is a cross-sectional view of the sill strip as shown in FIG. 5A, taken along line 5B-5B;

FIGS. 6A and 6B are bottom and top cross-sectional views, respectively, of the embodiment of a side jamb, as shown in FIG. 1, in accordance with the present invention;

FIG. 7 is a top cross-sectional view of the embodiment of vertical cladding, as shown in FIG. 1, in accordance with the present invention;

FIG. 8 is a top view of the integral sill corner, as shown in FIG. 2A, and the lineal base member, as shown in FIG. 3A, in an assembled state;

FIG. 9 is a cross-sectional view of the sill components as shown in FIG. 8, taken along line 9-9;

FIG. 10 is a partial perspective view of an alternate embodiment of an integral sill corner in accordance with the present invention;

FIG. 11A is a top view of the sill corner as shown in FIG. 10;

FIG. 11B is a left-side view of the sill corner as shown in FIG. 10;

FIG. 11C is a right-side view of the sill corner as shown in FIG. 10;

FIG. 12 is a top view of an alternate embodiment of a sill cap in accordance with the present invention; and

FIG. 13 is a top view of an alternate embodiment of a sill strip in accordance with the present invention.

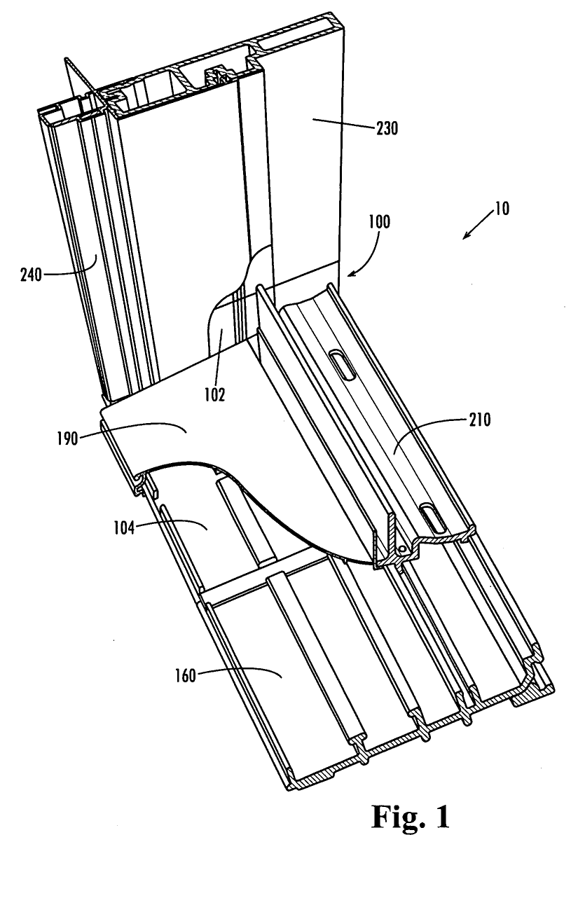

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used in another embodiment to yield a still further embodiment. Thus, it is intended that the present invention covers such modifications and variations as come within the scope of the appended claims and their equivalents.

Referring now to the Figures, a sill corner assembly 10 in accordance with the present invention is shown. In the preferred embodiment shown, sill corner assembly 10 is configured for use with an in-swing style door and includes an integral sill corner 100, a lineal base member 160, a sill cap 190, a sill strip 210, a side jamb 230 and vertical cladding 240. Lineal base member 160 is received adjacent a planar surface 104 of integral corner 100, thereby forming the horizontal component of sill corner assembly 10, and side jamb 230 is received adjacent an upstand 102 of integral sill corner 100, thereby forming the vertical component of sill corner assembly 10. Sill cap 190 and sill strip 210 are slidably received on both planar surface 104 of sill corner 100 and lineal base member 160, and vertical cladding 240 is slidably received on both upstand 102 of sill corner 100 and side jamb 230 to complete sill corner assembly 10, as discussed in greater detail below.

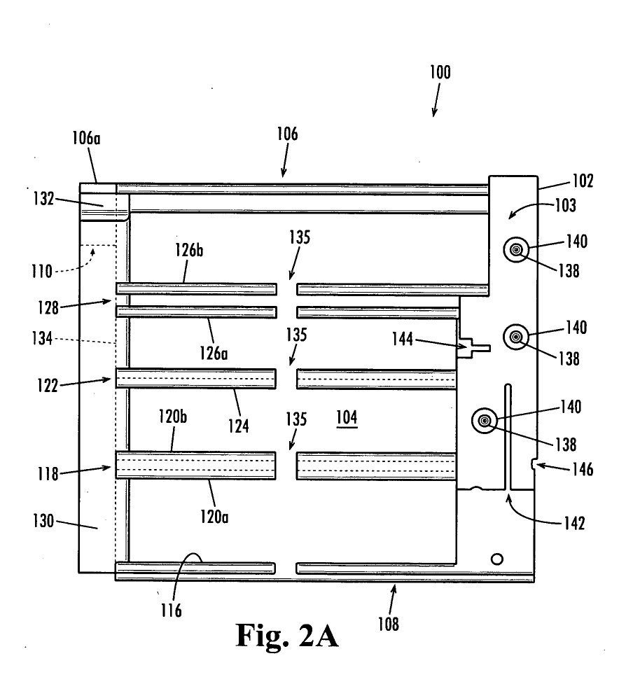

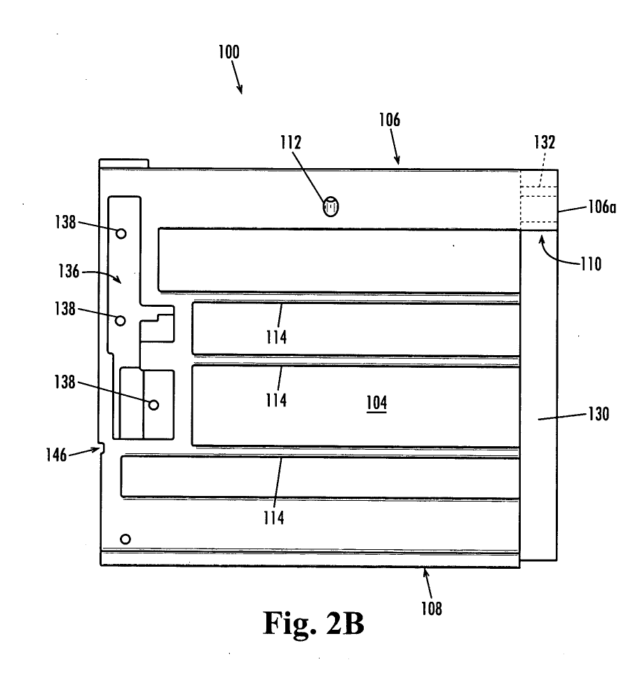

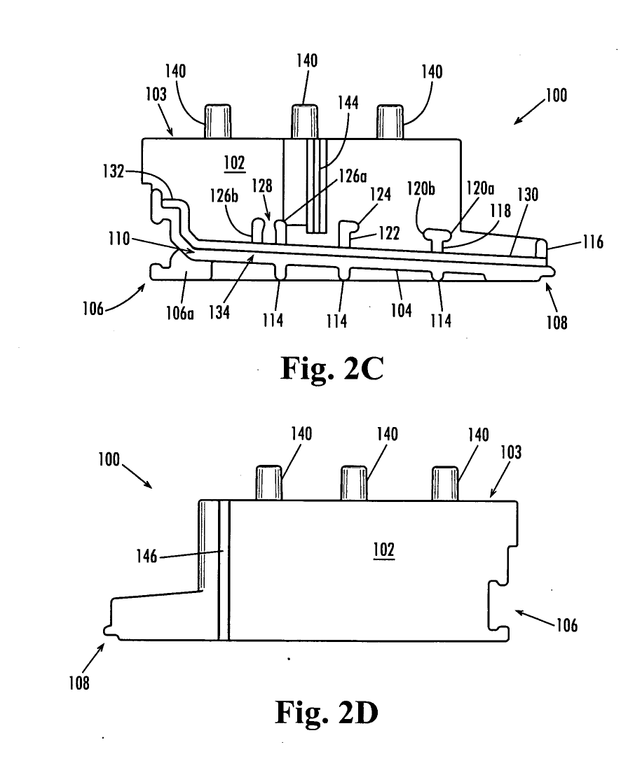

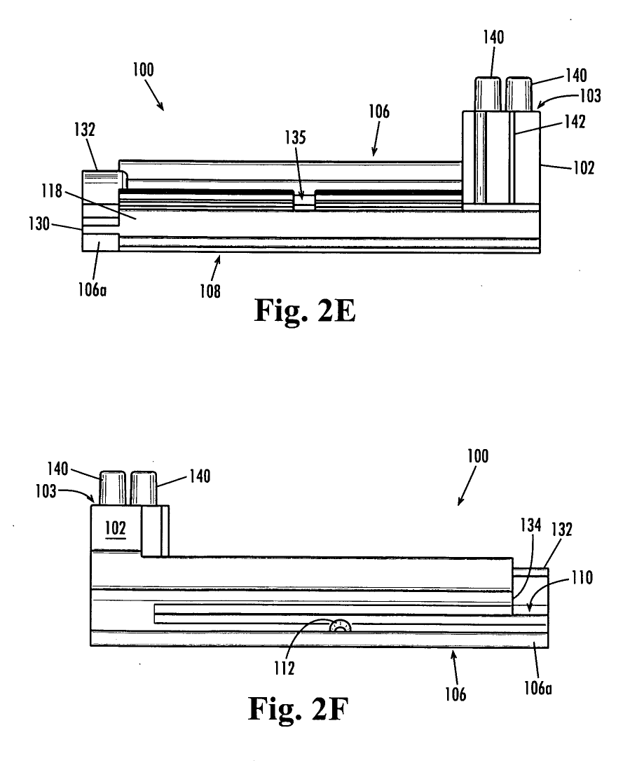

Referring now to FIGS. 2A through 2F, integral sill corner 100 in accordance with the present invention is shown. Sill corner 100 includes a vertical component, or upstand 102, and a horizontal component including a planar surface 104 extending between a rear base 106 and a front base 108. Rear base 106 defines a plurality of angled apertures 112 therethrough. Apertures 112 are configured to receive fasteners, such as screws, therein so that sill corner 100 can be secured to a base surface (not shown), such as a subfloor. A plurality of support ribs 114 extend downwardly from planar surface 104 such that they contact the base surface to which sill corner 100 is secured, thereby providing structural integrity. In the embodiment shown, sill corner 100 is formed by injection molding such that sill corner 100 is a unitary element with no seams or joints present. However, various other manufacturing methods can be used.

A first support rib 116 extends upwardly from planar surface 104 along the length of front base 108. A second support rib 118 extends upwardly from planar surface 104 and includes a pair of outwardly depending ledges 120a and 120b. A third support rib 122 extends upwardly from planar surface 104 and includes an outwardly depending ledge 124. A pair of fourth support ribs 126a and 126b extend upwardly from planar surface 104 and form a retaining groove 128 therebetween. The upper-most portions of fourth support ribs 126a and 126b are slightly larger than the bases of the fourth support ribs such that retaining groove 128 is more narrow at the top of the ribs than at the base. A seam cover 130 extends rearwardly from front base 108 along an abutting edge 134 of sill corner 100 and terminates at rear base 106 with a projection 132. A portion of seam cover 130 and a portion 106a of rear base 106 form a receiving groove 110 adjacent a portion of abutting edge 134. A plurality of gaps 135 is formed in each of first 116, second 118, third 122 and fourth 126a, 126b support ribs to allow the passage of water. As well, planar surface 104 angles downwardly from rear base 106 to front base 108, preferably at an angle in the range of about 3 degrees to about 5 degrees, and most preferably about 4 degrees.

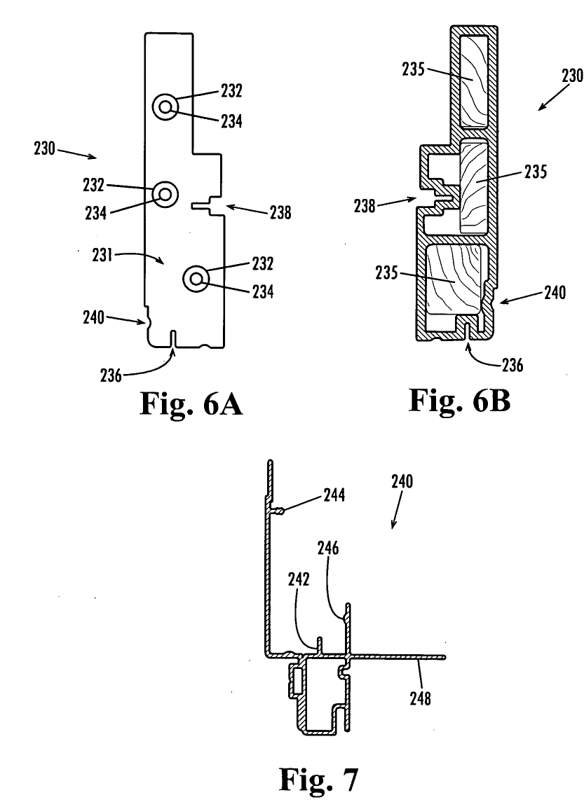

Upstand 102 of sill corner 100 includes a plurality of apertures 138 extending from a recessed portion 136 on its bottom surface through a plurality of posts 140 on its upper surface. Apertures 138 are configured to receive the plurality of fasteners such that side jamb 230 (FIGS. 6A and 6B) can be secured to upstand 102 of sill corner 100. A top surface 103 of upstand 102 and a bottom surface 231 of side jamb 230 form a joint 300 therebetween. Preferably, threaded fasteners are used to secure side jamb 230 to upstand 102. A front slot 142, a side slot 144, and a side groove 146 are also formed in the outer surface of upstand 102.

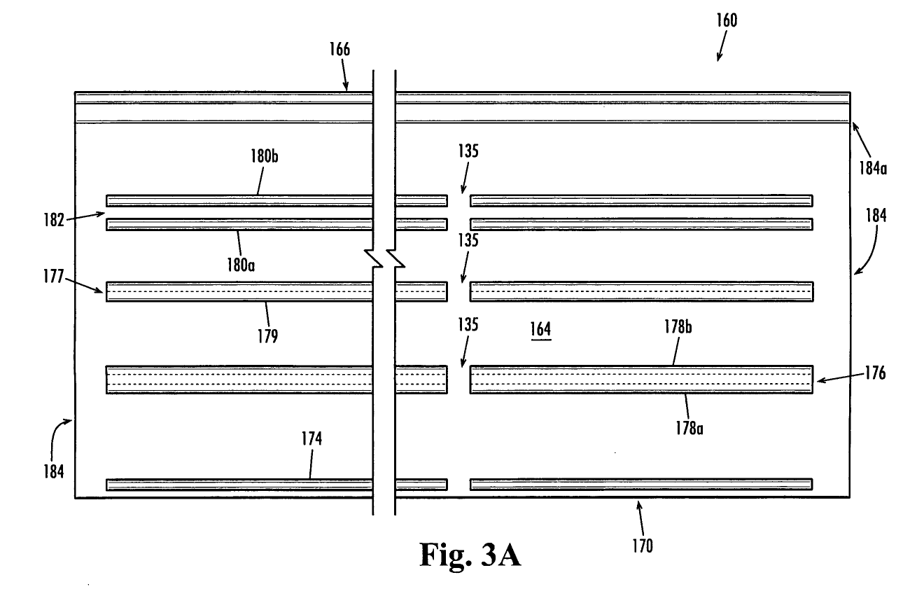

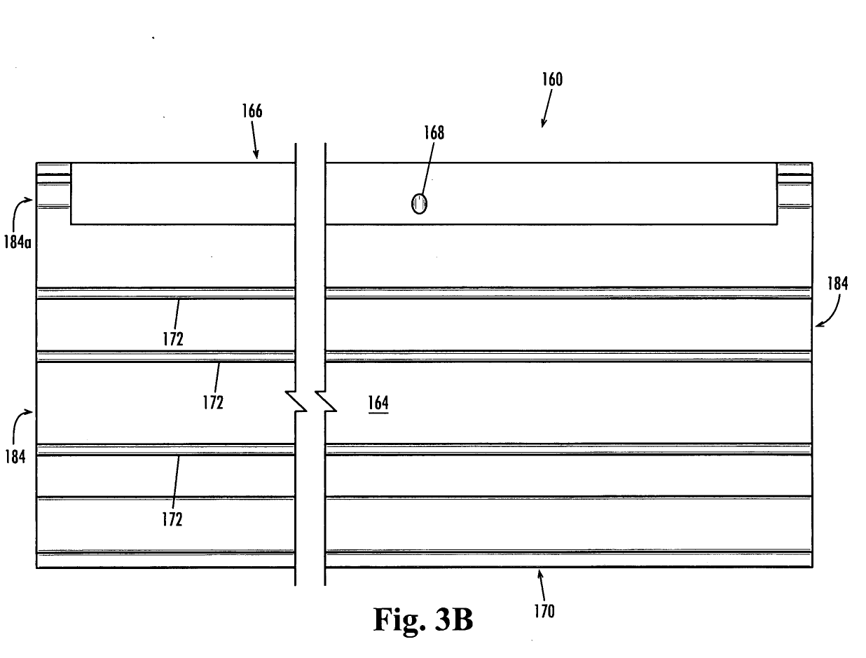

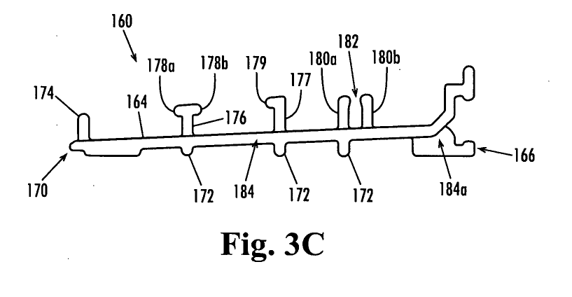

Referring now to FIGS. 3A through 3C, lineal base member 160 in accordance with the present invention is shown. Lineal base member 160 includes a planar surface 164 extending between a rear base 166 and a front base 170. Similar to sill corner 100, rear base 166 defines a plurality of angled apertures 168 that are configured to receive fasteners so that lineal base member 160 can be secured to the base surface. As well, a plurality of support ribs 172 extend downwardly from planar surface 164 such that they contact the base surface, thereby providing structural integrity to lineal base member 160.

A first support rib 174 extends upwardly from planar surface 164 along the length of front base 170. A second support rib 176 extends upwardly from planar surface 164 and includes a pair of outwardly depending ledges 178a and 178b. A third support rib 177 extends upwardly from planar surface 164 and includes an outwardly depending ledge 179. A pair of fourth support ribs 180a and 180b extend upwardly from planar surface 164 and define a retaining groove 182 therebetween. The upper-most portion of fourth support ribs 180a and 180b are slightly larger than the bases of the fourth support ribs such that retaining groove 182 is more narrow at the top of the support ribs than at the base. A pair of abutting edges 184 are disposed on opposing ends of lineal base member 160 and are configured to abut a corresponding abutting edge 134 of sill corner 100 such that a portion 184a of abutting edge 184 is received in receiving groove 110. Planar surface 164 extends downwardly from rear base 166 to front base 170 at an angle that corresponds to the angle at which planar surface 104 of sill corner 100 extends downwardly from rear base 106 to front base 108 (preferably an angle of from about 3 degrees to about 5 degrees, most preferably about 4 degrees). As well, the first, the second, the third and the fourth support ribs include a plurality of gaps 135 formed therein to allow the passage of water.

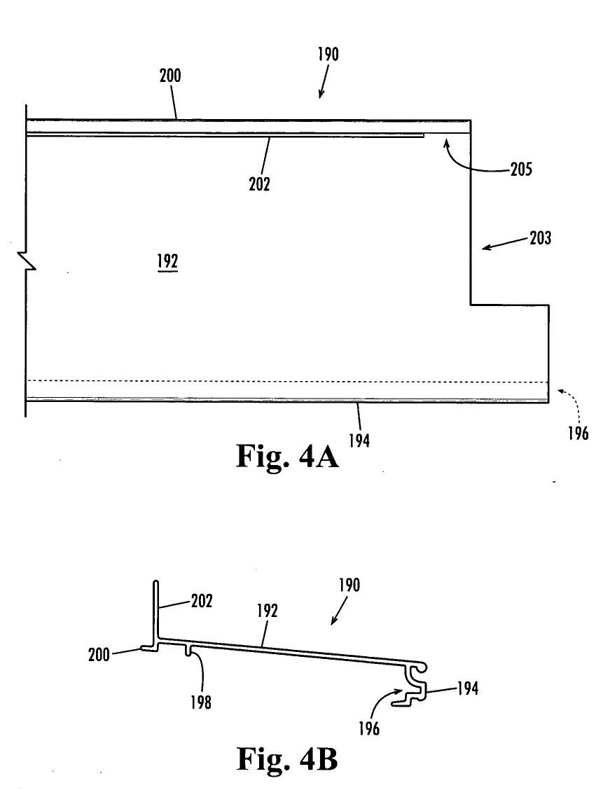

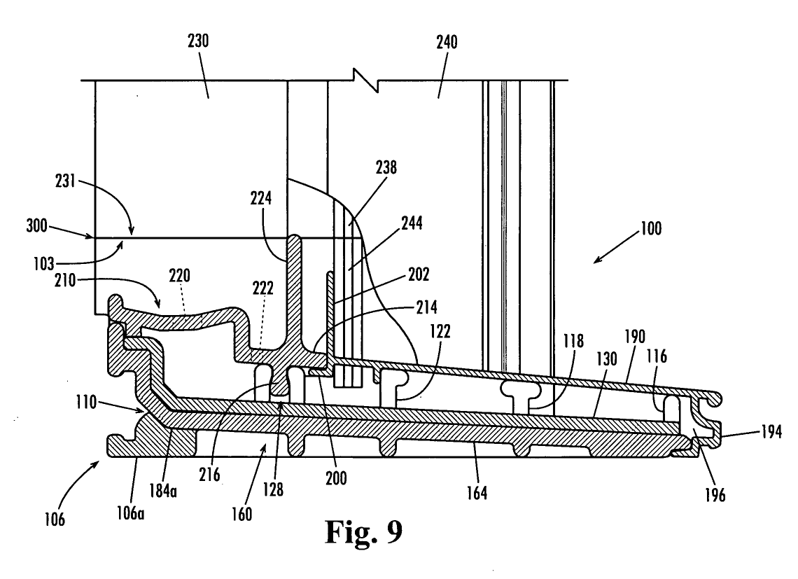

Referring now to FIGS. 4A and 4B, sill cap 190 in accordance with an embodiment of the present invention is shown. Sill cap 190 includes a planar surface 192 extending between a front lip 194 and a rear ledge 200. Front lip 194 is configured to engage front base 108 of sill corner 100, and is also configured to form a drainage path 196 for water along front base (FIG. 9). A rib 198 extends downwardly from planar surface 192 and is configured to engage a rear portion of third support rib 122 on sill corner 100 (FIG. 9). A rear fin 202 extends upwardly from planar surface 192 adjacent rear ledge 200. An abutting end 203 of sill cap 190 is configured to abut upstand 102 of sill corner 100. However, a gap 205 is provided in rear fin 202 such that rear fin 202 does not abut upstand 102. As such, gap 205 allows fluid to escape from behind rear fin 202 and pass down planar surface 192.

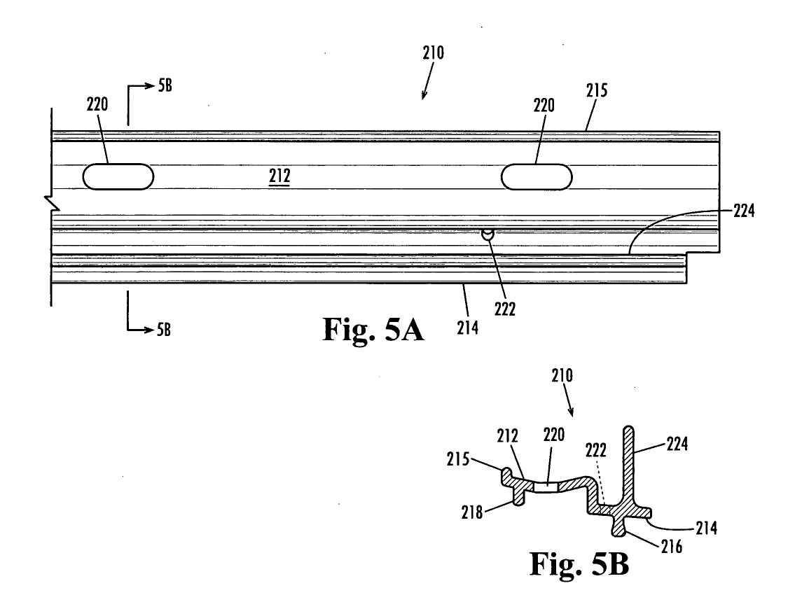

Referring now to FIGS. 5A and 5B, sill strip 210 in accordance with an embodiment of the present invention is shown. Sill strip 210 includes a top surface extending between a front ledge 214 and back rib 215. A retaining rib 216 extends downwardly from sill strip 210 and is configured to be received by retaining groove 128 of sill corner 100 and retaining groove 182 of lineal base member 160 in a snap-fit (FIG. 9). As such, the lower-most portion of retaining rib 216 is slightly enlarged such that it is securely engaged by the slightly enlarged ends of fourth support ribs 126a, 126b and 180a, 180b. A rib 218 extends downwardly from sill strip 210 adjacent back rib 215 and is configured to abut rear base 106 of sill corner 100 (FIG. 9). A gap (not shown) is formed in rear rib 218 for receiving projection 132 of seam cover 130 therein. A fin 224 extends upwardly from top surface 212. Fin 224 is configured to abut the bottom portion of a door (not shown), thereby blocking elements from passing between fin 224 and the door. A plurality of apertures 220 and 222 are defined by sill strip 210 and allow water to pass through sill strip 210 onto planar surface 104 of sill corner 100 for drainage therefrom.

Referring now to FIGS. 6A and 6B, side jamb 230 in accordance with the present invention is shown. The lower portion of side jamb 230 includes a plurality of post recesses 232, each being formed about a respective aperture 234. Post recesses 232 are each configured to receive one of the plurality of posts 140 disposed on top surface 103 of upstand 102. Apertures 234 are configured to receive fasteners (not shown) such that side jamb 230 can be securely attached to upstand 102 of sill corner 100. Side jamb 230 includes a front slot 236, a side slot 238 and a side groove 240 that correspond to front slot 142, side slot 144 and side groove 146 formed in upstand 102 of sill corner 100. In the embodiment shown, wooden members 235 are disposed within the upper portion of side jamb 230 to assist in securely seating side jamb 230 to sill corner 100 with threaded fasteners.

Referring now to FIG. 7, a portion of vertical structural cladding 240 in accordance with the present invention is shown. Vertical cladding 240 includes a front fin 242, a side fin 244 and a side projection 246. Front fin 242, side fin 244 and side projection 246 are configured to be slidably received by the corresponding front slots 142 and 236, side slots 144 and 238 and side grooves 146 and 230 of upstand 102 and side jamb 230, respectively A nailing fin 248 extends outwardly from vertical cladding 240 such that the sill constructed from the discussed sill components can be secured in a rough opening of a building structure. More specifically, the nailing fin 248 is adapted to be positioned adjacent a structural support of the building structure and secured thereto with a fastener, such as a nail, screw, etc., that is received through the nailing fin 248 and extends into the structural support.

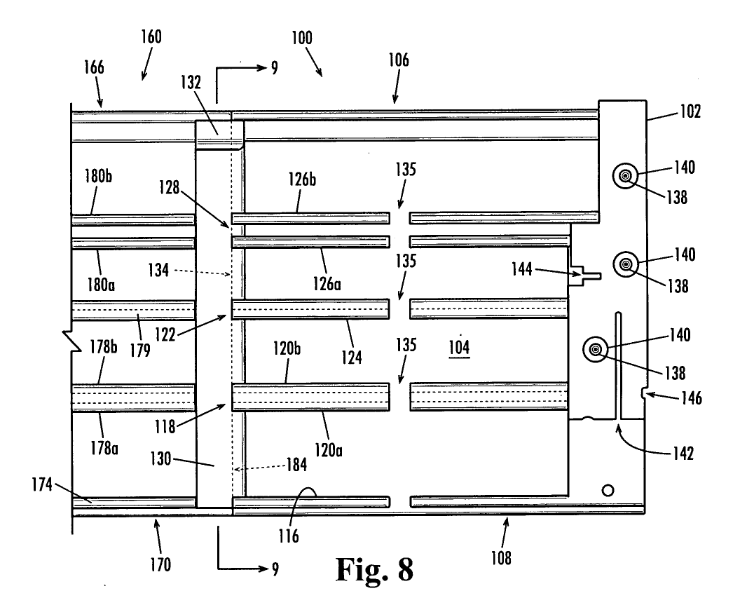

As shown in FIG. 8, sill corner 100, as shown in FIGS. 2A through 2F, and lineal base member 160, as shown in FIGS. 3A through 3C, are assembled. Referring also to FIG. 9, to assemble sill corner 100 and lineal base member 160, abutting edge 184 of lineal base member 160 is positioned adjacent abutting edge 134 of sill corner 100. As such, a portion 184a of lineal base member 160 is received in receiving groove 110 which is defined by portion 106a of rear base 106 of sill corner 100 and seam cover 130. Seam cover 130 extends along the entire length of the seam between abutting surfaces 134 and 184. Seam cover 130 prevents a direct flow path from the top surface of the sill to the bottom surface.

As best seen in FIG. 9, to further assemble the sill, front base 108 of sill corner 100 is engaged with front lip 194 of sill cap 190 and third support rib 122 of sill corner 100 is engaged by rib 198 of sill cap 190. Retaining rib 216 of sill strip 210 is pushed downwardly into receiving groove 128 of sill corner 100 until sill strip 210 snaps into place. In so doing, front ledge 214 of sill strip 210 engages rear ledge 200 of sill cap 190, thereby holding sill cap 190 in position. When secured to sill corner 100, planer surface 192 of sill cap 190 is supported from underneath by the first, the second and the third support ribs of sill corner 100 and lineal base member 160. The support ribs of lineal base member 160 are similarly engaged by sill cap 190 and sill strip 210, but that description is not included herein for ease of description.

As previously noted, posts 140 on upstand 102 are slidably received in post recesses 232 formed in the bottom portion of side jamb 230. Preferably, threaded fasteners are passed from the underside of upstand 102 through apertures 138 and 234 in order to secure side jamb 230 to upstand 102. Next, vertical cladding 240 is positioned on side jamb 230 and upstand 104 by engaging the front slots, the side slots and the side grooves formed thereon with front fin 242, side fin 244 and side projection 246, respectively. As previously noted, a joint 300 is formed between upstand 102 of sill corner 100 and side jamb 230 by their top surface 103 and bottom surface 231, respectively. In the preferred embodiment shown, joint 300 is disposed about 1.44 inches above the base surface (not shown) to which the sill is secured. In the preferred embodiment shown, this height is determined based on achieving a differential pressure of at least 50 psi between the interior and exterior of the structure in which the sill and associated door are installed, without a column of water being able to reach the height of joint 300. The height of top surface 103 of upstand 102, and subsequently joint 300, can be increased or decreased dependent upon the desired differential pressure. For example, the height of top surface 103 of upstand 102 could be as little as about 1.00 inch or as much as about 4.00 inches.

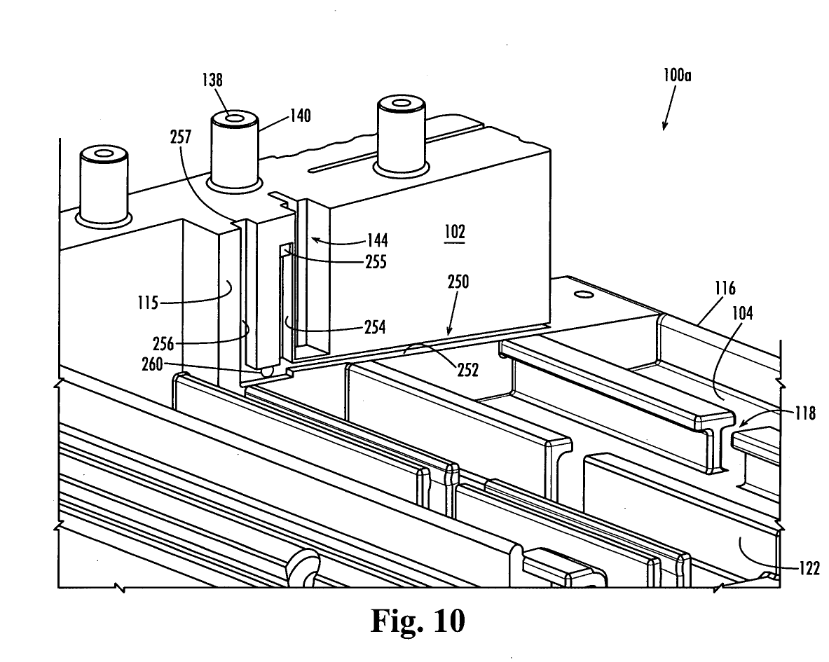

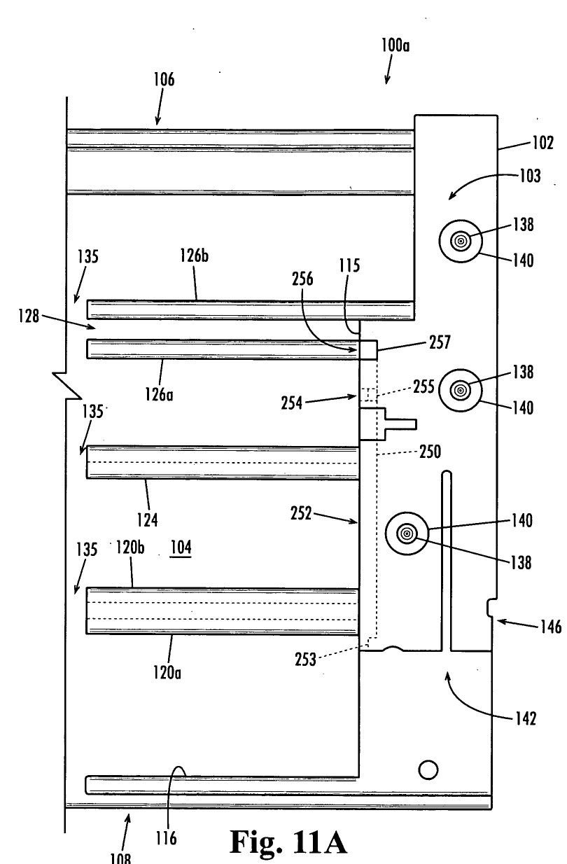

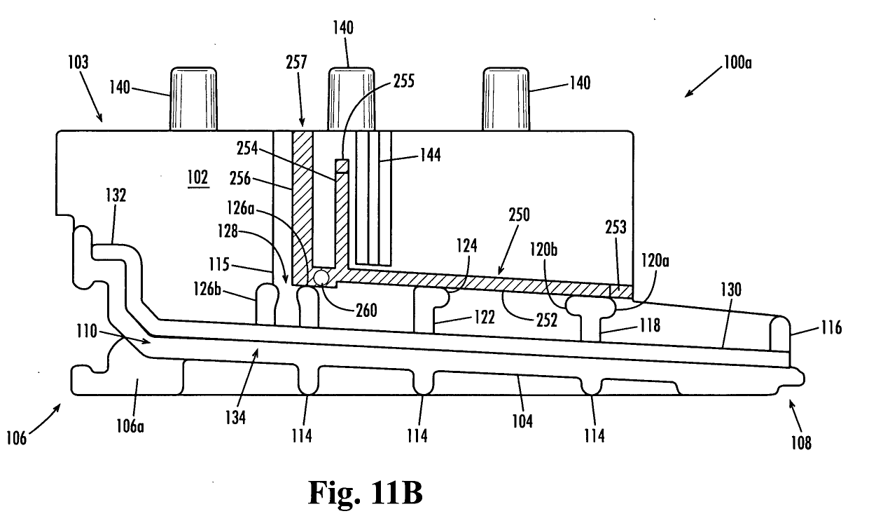

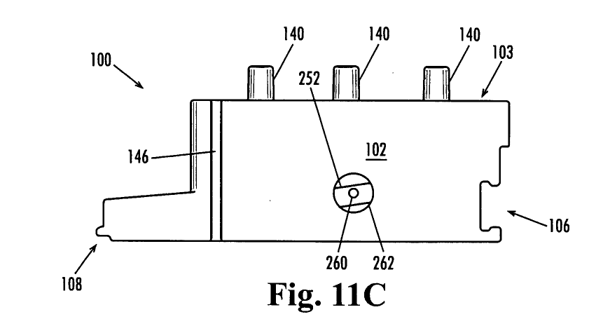

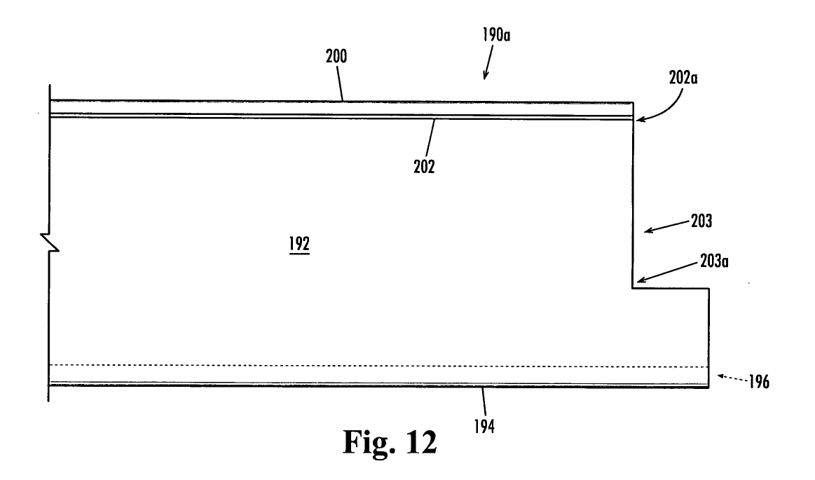

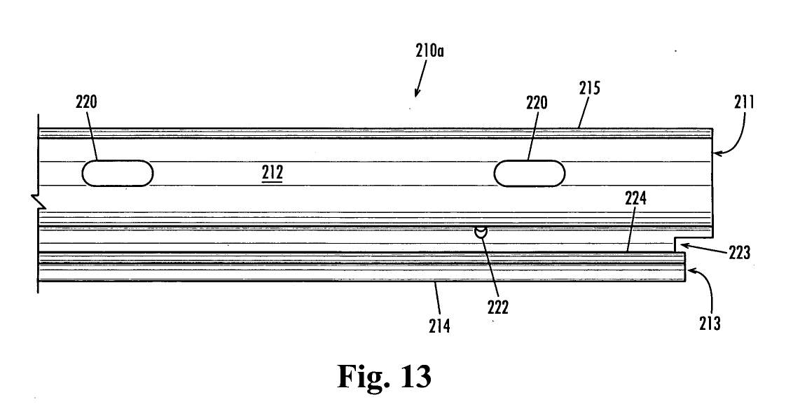

Referring now to FIGS. 10 and 11A through 11C, an alternate embodiment of an integral sill corner 100a in accordance with the present invention is shown. Sill corner 100a is configured in substantially the same manner as previously discussed sill corner 100 (FIGS. 2A through 2F), and as such, similar components are similarly numbered and a discussion of the majority of the these components is not repeated here. As shown, sill corner 100a includes a vertical upstand 102 and a substantially horizontal component including a planar surface 104 extending between a rear base 106 and a front base 108. Rear base 106 defines a plurality of angled apertures (not shown) that are configured to receive fasteners, such as screws, therein so that sill corner 100a can be secured to a base surface (not shown), such as a subfloor. Sill corner 100a differs primarily from the previously discussed embodiment in that upstand 102 defines a sealant pathway 250 that is configured to slidably receive portions of both a sill cap 190a (FIG. 12) and a sill strip 210a (FIG. 13), yet allow a liquid sealant to be injected into, and flow along, sealant pathway 250, as discussed in greater detail below.

As best seen in FIGS. 11A and 11B, sealant pathway 250 extends inwardly into upstand 102 of sill corner 100a from the inner surface of upstand 102. Sealant pathway 250 includes a horizontal portion 252, a first vertical portion 254 and a second vertical portion 256, as indicated by the cross-hatching in FIG. 11B. Horizontal portion 252 extends rearwardly from the front base portion of upstand 102 and terminates at second vertical portion 256. Horizontal portion 252 is configured to slidably receive an abutting end 203 of sill cap 190a (FIG. 12) and an abutting end 211 of sill strip 210a (FIG. 13) in a snug fit such that any loss of liquid sealant from sealant pathway 250 prior to curing is minimized. First vertical portion 254 extends upwardly from horizontal portion 252 and terminates before reaching the top surface of upstand 102. In contrast, second vertical portion 256 extends upwardly from the rearward-most end of horizontal portion 252, but extends to the top surface of upstand 102 where it terminates with an aperture 257. First vertical portion 254 and second vertical portion 256 are configured to slidably receive rear fin 202 of sill cap 190a and fin 224 of sill strip 210a, respectively, in a snug fit such that liquid sealant is retained in sealant pathway 250 prior to curing. Note, in the preferred embodiment shown, side slot 144 does not intersect horizontal portion 252 of sealant pathway 250.

To insure that adequate room remains in sealant pathway 250 after the insertion of abutting end 203 of sill cap 190a therein, a first stub 253 extends into sealant pathway 250 adjacent the forward base of upstand 102 and a second stub 255 extends into sealant pathway adjacent the upper-most portion of first vertical portion 254. Referring additionally to FIG. 12, when abutting end 203 of sill cap 190a is slidably received in sealant pathway 250, a portion 203a of abutting end 203 abuts first stub 253 and a portion 202a of rear fin 202 abuts second stub 255, thereby preventing sill cap 190a from extending fully into sealant pathway 250, which would inhibit the flow of liquid sealant therein.

Similarly, as shown in FIG. 13, abutting end 211 of sill strip 210a is configured to prevent the end of sill strip 210a from being fully inserted into sealant pathway 250. More specifically, abutting end 211 of sill strip 210a extends outwardly beyond the outer-most end of fin 224 such that fin 224 extends only partially into second vertical portion 256 of sealant pathway 250 when abutting end 211 is in full contact with the inner surface of upstand 102. A notch 223 is defined between the outer-most portions of abutting end 211 and fin 224 of sill strip 210a and is configured to slidably receive vertical wall 115 of upstand 102.

Bottom surface 231 of side jamb 230 (FIG. 6A) serves to block aperture 257 at the top end of second vertical portion 256 once side jamb 230 has been secured to upstand 102. As well, the abutment of portion 203a of sill cap 190a with first stub 253 provides a seal at the forward-most portion of sealant pathway 250. Once assembled, and both ends of sealant pathway 250 are sealed as noted above, liquid sealant is injected into sealant pathway 250 by way of injection port 260. As best seen in FIG. 11C, injection portion 260 is readily accessible by way of an aperture 262 that is formed in the outside wall of upstand 102.

While one or more preferred embodiments of the invention are described above, it should be appreciated by those skilled in the art that various modifications and variations can be made in the present invention without departing from the scope and spirit thereof.

What is claimed:

1. A sill corner for use in a sill assembly supported on a base surface, the sill assembly comprising a vertical jamb and a lineal base member, the sill corner comprising:
a vertical component comprising a top surface adapted to receive the vertical jamb and a bottom surface adapted to abut the base surface; and
a horizontal component extending transversely from the vertical component, the horizontal and the vertical components being a unitary element,
wherein the top and bottom surfaces of the vertical component are separated by a height, the height being between about 1.00 and about 3.00 inches.

2. The sill corner of claim 1, wherein the height of the sill corner is between about 1.44 and about 2.00 inches.

3. The sill corner of claim 1, wherein the top and bottom surfaces of the vertical component are substantially planar and substantially parallel to each other.

4. The sill corner of claim 1, wherein a distal end of the horizontal component comprises an abutment edge configured to abut a corresponding abutment edge disposed on the lineal base member.

5. The sill corner of claim 4, wherein the horizontal component further comprises a seam cover disposed above and along the abutment edge such that when the corresponding abutment edges of the horizontal member and the lineal base member are in abutment, the abutment edges are disposed beneath the seam cover.

6. The sill corner of claim 1, wherein the horizontal component further comprises a rear base, a front base, and a top planar surface that extends downwardly from the rear base to the front base at an angle of about 3 degrees to about 5 degrees from a horizontal plane that is substantially parallel to the base surface.

7. The sill corner of claim 6, wherein the angle is about 4 degrees.

8. The sill assembly of claim 1, wherein the height is about 1.44 inches.

9. A sill assembly configured to be supported on a base surface, the sill assembly comprising:
a sill corner comprising a vertical component comprising a substantially planar top surface and a horizontal component, the vertical and horizontal components being integrally formed; and
a vertical jamb comprising a substantially planar bottom surface, the substantially planar bottom surface abutting the planar top surface such that a joint is formed,
wherein the joint is disposed at a height above the base surface, the height being between about 1.00 and about 3.00 inches.

10. The sill assembly of claim 9, wherein the horizontal component of the sill corner further comprises a substantially planar top surface that extends downwardly from a rear edge to a front edge of the horizontal component at a first angle relative to a horizontal plane that is substantially parallel to the base surface.

11. The sill assembly of claim 10, further comprising a sill cap comprising a rear ledge, a front lip and a substantially planar surface extending therebetween, wherein the front lip of the sill cap is adapted to engage the front edge of the horizontal component and the rear ledge is adapted to engage a first portion of the top planar surface of the sill corner.

12. The sill assembly of claim 11, wherein the front lip of the sill cap and the front edge of the horizontal component form an internal drainage path along the front edge of the horizontal component.

13. The sill assembly of claim 11, wherein the sill corner further comprises a first support rib extending upwardly from the substantially planar top surface of the horizontal component such that the first support rib contacts a bottom surface of the planar surface of the sill cap.

14. The sill assembly of claim 13, wherein the first support rib is substantially parallel to a longitudinal axis of the horizontal component.

15. The sill assembly of claim 13, wherein the first support rib further comprises a first portion and a second portion separated by a gap, thereby forming a drainage path along the top planar surface.

16. A method of making a sill corner for use in a sill assembly supported on a base surface, the sill assembly comprising a vertical jamb and a lineal base member, the method comprising:
providing a vertical component comprising a substantially planar top surface adapted to receive the vertical jamb and a bottom surface adapted to abut the base surface; and
providing a horizontal component extending transversely from the vertical component, the horizontal and the vertical components being integrally formed,
wherein the top surface of the vertical component is substantially parallel to the bottom surface of the vertical component and the top surface and the bottom surfaces are separated by a height, the height being between about 1.00 and about 3.00 inches.

17. The method of making a sill corner of claim 16, wherein the height of the sill corner is between about 1.44 and about 2.00 inches.

18. The method of making a sill corner of claim 16, further comprising forming the sill corner by injection molding.

19. The method of making a sill corner of claim 16, wherein a distal end of the horizontal component comprises an abutment edge configured to abut a corresponding abutment edge disposed on the lineal base member.

20. The method of making a sill corner of claim 19, wherein the horizontal component further comprises a seam cover disposed above and along the abutment edge such that when the corresponding abutment edges of the horizontal member and the lineal base member are in abutment, the abutment edges are disposed beneath the seam cover.

21. A sill assembly configured to be supported on a base surface, the sill assembly comprising:
a sill corner comprising a vertical component and a horizontal component, the vertical and horizontal components being integrally formed, the vertical component comprising a sealant pathway formed therein; and
a sill cap comprising a first edge, the sill cap being configured to be slidably received by the horizontal component of the sill corner,
wherein the sealant pathway is configured to both slidably receive the first edge of the sill cap and direct a fluid sealant to flow along the first edge within the sealant pathway.

22. The sill assembly of claim 21, the sealant pathway further comprising a stub depending outwardly from a bottom wall of the sealant pathway, the height of the stub being less than the height of the sealant pathway and configured to abut the first edge of the sill cap when the sill cap is inserted into the sealant pathway.

23. The sill assembly of claim 21, wherein the sealant pathway further comprises a pair of opposed sidewalls and a bottom wall and the opposed sidewalls exert a friction force on the first edge of the sill cap.
